(19) United States
(12) Patent Application Publication
(10) Pub. No.: US 2010/0036562 A1
(43) Pub. Date: Feb. 11, 2010

(54) Driver Assistance System

(76) Inventor: Jan-Carsten Becker, Palo Alto, CA (US)

Correspondence Address: KENYON & KENYON LLP, ONE BROADWAY, NEW YORK, NY, 10004, US

(21) Appl. No.: 12/308,198

(22) PCT Filed: Jul. 11, 2007
(86) PCT No.: PCT/EP2007/057080

§ 371 Date: Oct. 13, 2009

(30) Foreign Application Priority Data
Aug. 23, 2006 (DE) 10 2006 039 583.2

(51) Int. Cl. B60W 30/14; B60W 30/12

(52) U.S. Cl. 701/41; 701/1

(57) ABSTRACT

In a driver assistance system having assistance functions determined by parameters, the driver assistance system is configured to be adaptive via modifiable parameters.

### BACKGROUND OF THE INVENTION

1. Field of the Invention

The present invention relates to a driver assistance system configured to be adaptive as a function of modifiable parameters.

2. Description of Related Art

In the area of driver assistance systems, the adaptive cruise control (ACC) system has been successfully implemented into a mass application, at least for an area of application limited to superhighways and multilane highways. Further assistance functions such as LDW (Lane Departure Warning), LKS (Lane Keeping Support), LCA (Lane Change Assistant), and braking assistant are already provided for the application in mass-production vehicles. For implementing these assistance functions, a driver assistance system includes surroundings sensors such as, for example, radar sensors, lidar sensors, laser scanners, video sensors, and ultrasound sensors. If a vehicle is equipped with a navigation system, the driver assistance system also resorts to the data of this system. Furthermore, the driver assistance system connected to the vehicle electric system, preferably via at least one bus, preferably the CAN bus, may actively intervene in vehicle systems such as the steering system, the brake system, the drive train, and warning systems. Drivers faced with such novel functions initially often feel overwhelmed and uneasy because they have the impression that they are disempowered by the vehicle, since many functions, actually serving the driver's safety, run without any action by the driver.

### BRIEF SUMMARY OF THE INVENTION

An object of the present invention is to provide a more user-friendly driver assistance system in such a way that it is more readily accepted by the driver of a vehicle equipped with the driver assistance system.

This object is achieved in that the driver assistance system is adaptable due to the fact that parameters of the driver assistance system and thus the interventions of the driver assistance system in the conduction of the vehicle are configured to be variable.

The present invention improves the acceptance of a driver assistance system in that it familiarizes the driver with its diverse assistance functions in a soft manner. In the present context, “soft” means that the driver is given a learning period allowing him to familiarize himself with the operation of the driver assistance system. During this learning period the driver assistance system responds not with the maximum design intensity of intervention, but allows the intensity of intervention to increase from a relatively low value gradually to the maximum design intensity. In an advantageous exemplary embodiment of the present invention, this learning period may be linked to the time of operation of the vehicle. In another embodiment variant, the learning period may be linked to events, namely the number of interventions of the driver assistance system. In a further embodiment variant, the intervention is started earlier and thus the duration of the intervention is prolonged, while the intensity of intervention is initially reduced.

### BRIEF DESCRIPTION OF THE SEVERAL VIEWS OF THE DRAWING

FIG. 1 shows a block diagram of a driver assistance system.

FIG. 2 shows a diagram of the functional relationship between the intensity of intervention and the operating time.

FIG. 3 shows a block diagram of an example embodiment of a driver assistance system.

FIG. 4 shows a block diagram of an example embodiment of a driver assistance system.

FIG. 5 shows a block diagram of an example embodiment of a driver assistance system.

FIG. 6 shows a block diagram of an example embodiment of a driver assistance system.

FIG. 7 shows another diagram showing the intensity of intervention as a function of time.

### DETAILED DESCRIPTION OF THE INVENTION

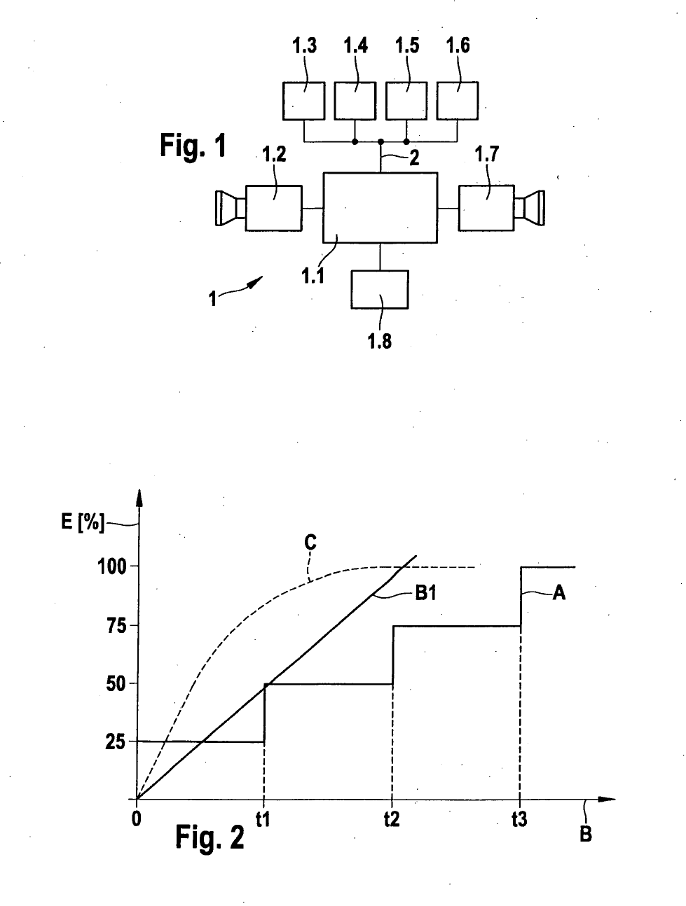

Specific example embodiments of the present invention are elucidated in greater detail below with reference to the drawings. A block diagram of a driver assistance system 1 designed according to the present invention is depicted in FIG. 1. The present invention uses at least one forward-looking sensor system 1.7 for lane detection. For this purpose, sensor system 1.7 includes at least one video sensor for optical detection of lane markings. Sensor system 1.7 is connected to a control unit 1.1. Driver assistance system 1 may furthermore advantageously include devices for distance measurement such as a radar sensor 1.3, a lidar sensor 1.4, a laser scanner 1.5 and an ultrasound sensor 1.6. Furthermore, driver assistance system 1 may include a GPS-supported navigation system 1.8 or be connected thereto. Finally, driver assistance system 1 may also include a backward-looking sensor system 1.2. Control unit 1.1 and the sensors and the navigation device are connected to each other via a bus system 2, preferably a CAN bus system, to enable high-speed data transmission.

In the following, specific example embodiments of the present invention are elucidated with reference to some concrete examples.

An imminent lane change of the host vehicle may be detected via the information on the position and orientation of the lane markings relative to the host vehicle via the data of the sensor system for lane detection. As one important assistance function of the driver assistance system, the Lane Keeping Support (LKS) function supports the driver in keeping in the selected traffic lane in that, in the event of imminent leaving of the traffic lane, the driver assistance system intervenes in the steering system of the vehicle by applying a restoring steering torque. For the untrained driver this may be surprising and result in an undesirable counter-response of the driver, who wishes to compensate for the steering torque applied by the driver assistance system. The present invention substantially contributes to familiarizing the driver with the driver assistance system by making him get gradually used to the interventions by the driver assistance system. According to the present invention, the parameters of the LKS assistance function are variably adapted to slowly get the driver used to this assistance function. This may take place in that driver assistance system 1 initially only offers a slight, soft-set steering support. The driver may thus experience the advantages of this assistance function in practice and slowly get used to it. The steering torque that is superimposed on the steering torque applied by the driver for keeping in the traffic lane may then be gradually increased until the maximum value provided by driver assistance system 1 is attained. The learning phase may advantageously be linked to the time of operation of the vehicle and individually adapted to a particular driver in that, when the vehicle is operated by a certain driver for the first time, only a slight steering support is applied, which is increased with continuing operation until the maximum value provided is attained. The time required therefor may be advantageously established empirically, for example, from test series. For example, a learning time of a few hours may be provided.

In order to also take into account a situation in which even over a longer time of operation of the vehicle only few interventions of the LKS assistance function occur, in another advantageous specific embodiment of the present invention, the duration of the learning phase is also made a function of the number of interventions of the assistance function. For example, in the event of a stepwise adaptation of the parameters responsible for the steering torque of the driver assistance system, the subsequent level may be reached after a number N of steering interventions on the previously set level. Since vehicles are often driven by a plurality of different drivers, assigning the learning phase to a particular driver is also advantageous. This may be accomplished easily in particular in modern vehicles which already have a device for identifying the particular driver. For this purpose, driver assistance system 1 makes a note of which stage of the learning phase the particular driver has already passed through when he sets the vehicle in operation. When the next time the same driver puts the vehicle in operation, the learning phase is continued from the noted point.

A similar procedure is conceivable in the case of a distance regulating function of the driver assistance system such as ACC (Automatic Adaptive Cruise Control) or for a braking assistance system. In this case, the braking intervention applied by the driver assistance system on the brake system of the vehicle may be increased from low values to the provided maximum value, for example.

In the case of a parking assistance system, only limited manipulated variables are offered in a learning phase of the driver assistance system. Thus, for example, larger distances to other parked vehicles or other obstacles are initially kept. During the learning phase the distances kept are then gradually reduced. It is furthermore possible to increase the velocity of the parking operation gradually. Initially the parking proceeds slowly. The vehicle's velocity during parking is then increased stepwise or continuously.

Depending on the application, the adaptation of the at least one parameter may be configured in functionally different ways. This is now elucidated with reference to FIG. 2: The diagram in FIG. 2 shows intensity of intervention E as a percentage of a maximum value as a function of operating time B. This operating time B corresponds to the above-mentioned learning time, once it is assumed that a new driver is taking over the new vehicle and subsequently familiarizes himself with it. The diagram shows three curves A, B1, C as examples, representing a functional relationship between intensity of intervention E and operating time B. Curve A is a step function. Intensity of intervention E of driver assistance system 1 thus changes step-wise in jumps. At point in time t=0, the learning phase for the new driver begins. Driver assistance system 1 responds with 25% of the maximum possible intensity of intervention. At point in time t1, intensity of intervention E increases to 50% of the maximum value. At point in time t2, intensity of intervention E increases further to 75% of the maximum value. Finally, at point in time t3, intensity of intervention E increases to 100%, i.e., to the maximum value provided by driver assistance system 1. Continuous curve B1 represents, as a variant, intensity of intervention E as a linear function of operating time B. Curve C represents a further variant. The variants of curves B1 and C are even more pleasant for the driver because gradual adaptation to the maximum value occurs during the learning phase. The curves depicted in FIG. 2 are to be understood as examples only. Of course, within the scope of the present invention it is also possible to implement more complex functional relationships if this is found to be advantageous within a certain application.

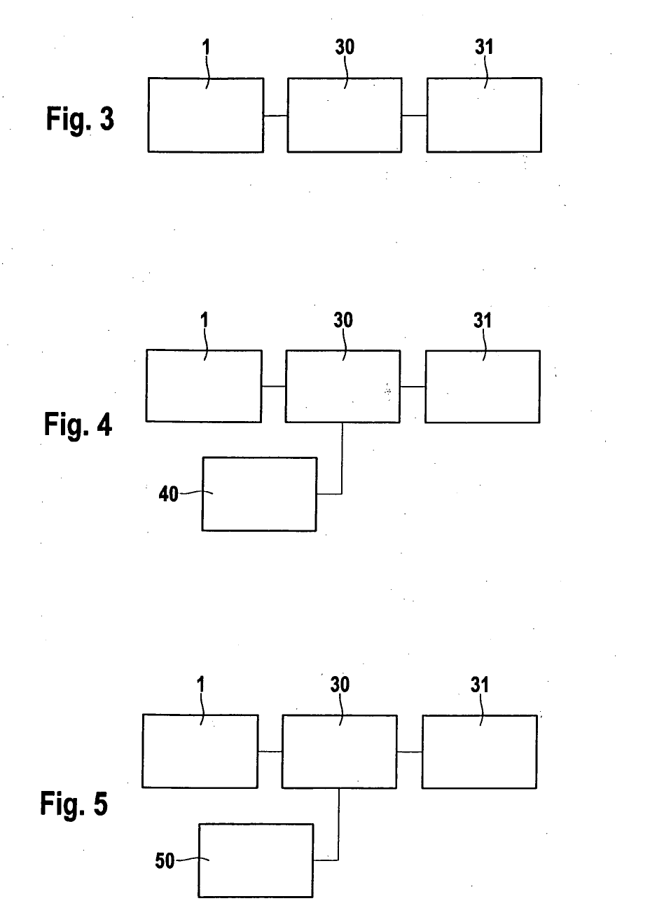

The block diagrams depicted in FIGS. 3 through 6 show specific example embodiments of driver assistance systems of the type according to the present invention. The block diagram of FIG. 3 shows driver assistance system 1 according to FIG. 1, omitting the sensors depicted in FIG. 1. Driver assistance system 1 is connected to a function module 30, which provides, for example, the functional relationship depicted in FIG. 2 between intensity of intervention E and time of operation B. Function module 30 is connected to a function module 31, which acts as an actuator and applies the functional relationship provided by function module 30 to the appropriate on-board systems of the vehicle such as, for example, the steering system or the brake system.

The embodiment variant depicted in FIG. 5 additionally includes a counter 50 connected to function module 30, which detects time of operation B of the vehicle and controls intensity of intervention E as a function thereof.

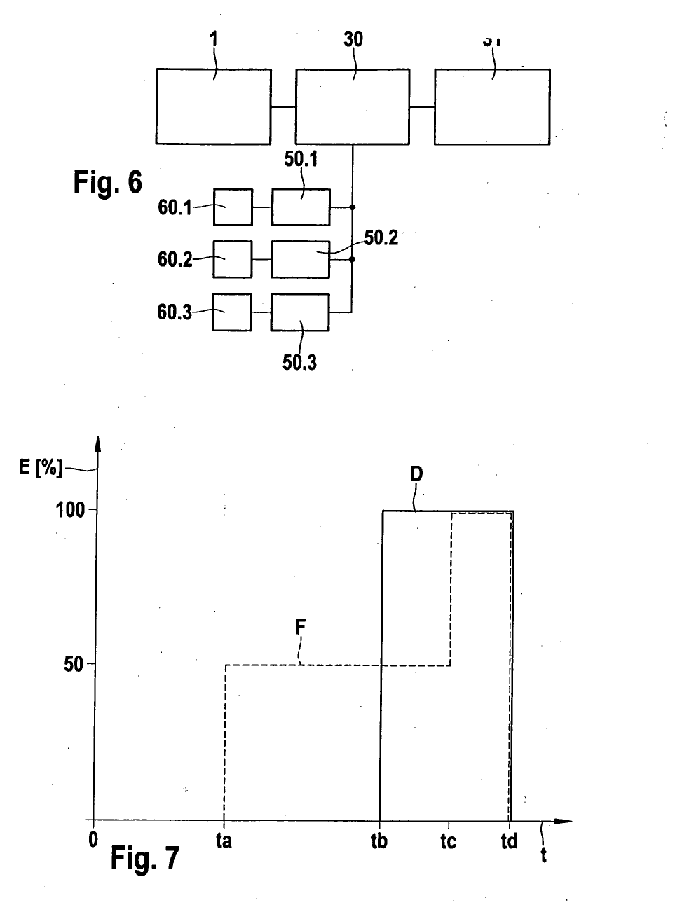

In the embodiment variant depicted in FIG. 6, counters 50.1, 50.2, 50.3 assigned to a plurality of different drivers are provided. They are connected to devices 60.1, 60.2, 60.3, respectively, for the identification of different drivers. Depending on which driver puts the vehicle into operation, the particular counter 50.1, 50.2, 50.3, which in turn controls via function module 30 the learning phase assigned to the corresponding driver, is selected via the corresponding device 60.1, 60.2, 60.3.

Similarly, the procedures linked above to the operating time may also run under event control. For this purpose, a counter, for example, counter 40 in FIG. 4, would count the number of interventions of driver assistance system 1. Intensity of intervention E would then be controlled as a function of the number of events according to a predefined functional relationship between intensity of intervention E and the number of events.

In another specific example embodiment of the present invention, getting used to an intervention of the driver assistance system may be achieved during the learning phase by starting an intervention earlier and by performing the intervention initially with reduced intensity. This is elucidated in the following using the example of a braking assistance function with reference to FIG. 7. FIG. 7 shows, in a diagram, intensity of intervention E as a function of the time of intervention. Time t is plotted on the abscissa of the coordinate system and intensity of intervention E is plotted on the ordinate. Curve D represents a customary braking intervention for an already trained driver. The braking intervention starts at point in time tb and lasts until point in time td, the braking intervention taking place at maximum intensity. Curve F depicts the braking intervention for a not yet trained driver. In this case, the braking intervention begins at an earlier point in time ta and at a reduced intensity of, for example, 50% of the maximum value. Only at point in time tc does intensity of intervention E increase to a higher value, here the maximum value, which is sustained until point in time td. The lower intensity of intervention makes it easier for the untrained driver to get used to the interventions of the driver assistance system. As more learning time elapses, the start of the intervention may be brought closer and closer to point in time tb, while the intensity of intervention is increased from one intervention to the next.

1-14. (canceled)

15. A driver assistance system for a vehicle, comprising:
at least one environment-sensing sensor; and
a control system configured to intervene in vehicle operation with at least one driver assistance function;
wherein at least one parameter of the at least one driver assistance function is configured to be adaptively varied based on at least one control characteristic.

16. The driver assistance system as recited in claim 15, wherein the at least one parameter of the at least one driver assistance function is configured to be adaptively varied as a function of a vehicle operating characteristic.

17. The driver assistance system as recited in claim 15, wherein the at least one parameter of the at least one driver assistance function is configured to be adaptively varied as a function of time.

18. The driver assistance system as recited in claim 16, wherein the at least one parameter of the at least one driver assistance function is configured to be adaptively varied as a function of events.

19. The driver assistance system as recited in claim 15, wherein the at least one parameter of the at least one driver assistance function is configured to be adaptively varied as a function of a driver of the vehicle.

20. The driver assistance system as recited in claim 19, wherein the at least one parameter of the at least one driver assistance function is configured to be adaptively varied according to a continuous characteristics curve.

21. The driver assistance system as recited in claim 20, wherein the at least one parameter of the at least one driver assistance function is configured to be adaptively varied according to a linear function.

22. The driver assistance system as recited in claim 20, wherein the at least one parameter of the at least one driver assistance function is configured to be adaptively varied according to a non-linear function.

23. The driver assistance system as recited in claim 19, wherein the at least one parameter of the at least one driver assistance function is configured to be adaptively varied according to a step function.

24. The driver assistance system as recited in claim 19, wherein the at least one driver assistance function is a lane-keeping-support function, and wherein in the lane-keeping-support function a steering torque applied by the driver assistance system is adaptively varied.

25. The driver assistance system as recited in claim 19, wherein the at least one driver assistance function is one of an adaptive cruise control function or a braking assistance function, and wherein in one of the adaptive cruise control function or the braking assistance function a braking torque applied by the driver assistance system is adaptively varied.

26. The driver assistance system as recited in claim 19, wherein the at least one driver assistance function is a parking assistance function, and wherein a distance of the vehicle to a surrounding obstacle during implementation of the parking assistance function is adaptively varied depending on a level of experience of the driver of the vehicle with the parking assistance function.

27. The driver assistance system as recited in claim 19, wherein the at least one driver assistance function is a parking assistance function, and wherein a speed of the vehicle during implementation of the parking assistance function is adaptively varied depending on a level of experience of the driver of the vehicle with the parking assistance function.

28. The driver assistance system as recited in claim 19, wherein at least one of a timing and intensity of intervention in vehicle operation with the at least one driver assistance function is adaptively varied depending on a level of experience of the driver of the vehicle with the at least one driver assistance function.
